(19) United States
(12) Patent Application Publication
(10) Pub. No.: US 2020/0073145 A1
(43) Pub. Date: Mar. 5, 2020

(54) VISION CARE KIT

(71) Applicant: Johnson & Johnson Vision Care, Inc., Jacksonville, FL (US)

(72) Inventors: Clint R. Frutiger, St. Johns, FL (US); Stephen C. Arnold, Jacksonville, FL (US); Salvatore G. Caldarise, St. Johns, FL (US); Charles W. Scales, St. Augustine, FL (US)

(21) Appl. No.: 16/536,444

(22) Filed: Aug. 9, 2019

Related U.S. Application Data
(60) Provisional application No. 62/727,020, filed on Sep. 5, 2018.

(51) Int. Cl. G02C 7/04; B65B 25/00; G02B 1/04

(52) U.S. Cl. CPC G02C 7/049; G02C 7/047; C11D 3/0078; G02B 1/043; B65B 25/008

(57) ABSTRACT

Provided are vision care kits and methods of their use. The kits contain first and second contact lenses having different primary functionalities or modalities, or both. The kits allow contact lens wearers to experience greater flexibility and customizability from their contact lenses.

### RELATED APPLICATIONS

This application claims priority to U.S. Provisional Patent Application Ser. No. 62/727,020, filed Sep. 5, 2018, which is incorporated herein by reference in its entirety.

### FIELD OF THE INVENTION

The invention relates to vision care kits and methods of their use. The kits contain contact lenses having different functionalities or modalities.

### BACKGROUND OF THE INVENTION

Contact lenses have been used commercially to improve vision since the 1950s. Currently available contact lenses remain a cost-effective means for vision correction. The thin plastic lenses fit over the cornea of the eye to correct vision defects, including myopia or nearsightedness, hyperopia or farsightedness, astigmatism, i.e., asphericity in the cornea, and presbyopia, i.e., the loss of the ability of the crystalline lens to accommodate.

Contact lenses are available in hard and soft varieties. Rigid gas permeable hard contact lenses are more rigid than soft contact lenses, do not contain water, and thus hold their shape and are more durable, but generally less comfortable. Soft contact lenses are typically made of a hydrogel material, which is a hydrated crosslinked polymeric system that contains water in an equilibrium state. Conventional hydrogels are prepared from monomeric mixtures predominantly containing hydrophilic monomers, such as 2-hydroxyethyl methacrylate (“HEMA”), N,N-dimethylacrylamide (DMA), or N-vinyl pyrrolidone (“NVP”). Silicone hydrogels contain silicone, which is known to increase the oxygen permeability of the lens compared to conventional hydrogel lenses.

Contact lenses are available in a variety of modalities. For instance, soft contact lenses are available in daily wear and extended wear modalities. Daily wear contact lenses are sold as daily disposable contact lenses which are usually worn for a single day and then thrown away and daily reusable contact lenses which are usually worn during the day and cleaned every night for a period of time, such as one or two weeks or one month prior to disposal. Extended wear lenses are another type of modality and are typically worn continuously for up to six, fourteen or thirty consecutive days and nights.

Contact lenses are available in many forms and are made of a variety of materials to provide different functionalities. For instance, colored or beauty soft contact lenses can be used to provide cosmetic functionality. Contact lenses having patterns and limbal rings made from translucent tints or pigments are designed to enhance the wearer's natural eye color. On the other hand, contact lenses made from darker, opaque tints are meant to change the wearer's eye color.

Bifocal or multifocal contact lenses are designed specifically for patients with presbyopia and are available in both soft and rigid varieties. Toric contact lenses are designed for patients with astigmatism and are also available in both soft and rigid varieties.

Soft contact lenses have been developed as drug delivery devices for the ophthalmic environment where the pharmaceutical agent is, for example, incorporated into the body of the lens or is added to the packing solution that is contained in the contact lens package where it is absorbed by the contact lens. The contact lens delivers the pharmaceutical agent to the ocular environment when the user wears the contact lens.

Soft contact lenses have been developed to aid wearers in managing varying light conditions. For instance, photochromic contact lenses change their transmission properties in response to external light conditions and therefore adapt to the environment. Contact lenses that absorb specific wavelength ranges of light such as ultraviolet (UV) light or high energy visible (HEV) light have also been developed.

Other hard and soft lenses with other primary functionalities are known or are under development.

Even though a wide variety of contact lens modalities and functionalities are available or are under development, contact lens wearers generally are fitted with only one kind of lens, such as a vision correcting reusable lenses, or vision correcting daily disposable lenses. Patients, however, have complex lifestyles and interests, resulting in vision needs that may differ depending on the particular activity in which they are engaged. For instance, a patient may require lenses that are suited for prolonged viewing of a computer screen during the week, while preferring lenses that offer sharper vision during the weekend for outside activities.

Further, contact lenses can vary widely in cost, even within a particular manufacturer's line of products. For example, soft contact lenses of the daily disposable modality are generally more expensive than those of the two week or monthly modality. Some patients may desire the convenience of the daily disposable modality, but only some of the time (for instance, they may wish to have daily disposable lenses only on the weekend or while travelling). Such patients, however, are typically fitted with daily disposable lenses for use all of the time, and are therefore required to pay the higher costs, even though their need for those particular lenses is periodic.

It would be an advance in the contact lens field to provide patients with vision care solutions that are more closely aligned to wearers' needs, lifestyles, and activities in which they engage.

### SUMMARY OF THE INVENTION

In one aspect, the invention provides a vision care kit. The vision care kit comprises: (a) a first contact lens having a first contact lens primary functionality and a first contact lens modality; and (b) a second contact lens having a second contact lens primary functionality and a second contact lens modality, wherein (1) the first contact lens primary functionality is different from the second contact lens primary functionality; or (2) the first contact lens modality is different from the second contact lens modality; or (3) the first contact lens primary functionality is different from the second contact lens primary functionality and the first contact lens modality is different from the second contact lens modality. The kit of the invention may contain several quantities of the first contact lens and/or the second contact lens, for instance as needed to provide a patient with a desired supply of lenses (e.g., a biweekly supply, a monthly supply, a biannual supply, a yearly supply, etc.). Thus, terms such “comprises a first contact lens” indicate that the kit contains at least one first contact lens. Similarly, the kit contains at least one second contact lens. Preferably the kit contains more than one first contact lens. Preferably, the kit contains more than one second contact lens.

In another aspect, the invention provides a vision care method. The method comprises the steps of: identifying a patient with two or more vision care needs; and dispensing to the patient a vision care kit as described herein.

### DETAILED DESCRIPTION OF THE INVENTION

As noted above, the invention provides a vision care kit and associated method. The kits and methods of the invention offer numerous advantages for patients, including better alignment to their particular vision and therapeutic care needs and greater flexibility in usability and cost.

For example, a patient that works in an office during the week but has an active lifestyle during the weekend, may be provided with a vision care kit according to the invention that contains contact lenses for office use and contact lenses for outdoor use.

A patient that suffers from seasonal allergies may, for example, be provided with a vision care kit that contains drug eluting lenses and non-drug eluting lenses. Such patient, therefore, may use the drug eluting lenses only when they suffer from, or anticipate suffering from, an allergic response to the environment. At other times, they may use the non-drug eluting lenses.

The vision care kit of the invention comprises: (a) a first contact lens having a first contact lens primary functionality and a first contact lens modality; and (b) a second contact lens having a second contact lens primary functionality and a second contact lens modality, wherein (1) the first contact lens primary functionality is different from the second contact lens primary functionality; or (2) the first contact lens modality is different from the second contact lens modality; or (3) the first contact lens primary functionality is different from the second contact lens primary functionality and the first contact lens modality is different from the second contact lens modality.

The first and second contact lenses contained in the kit have, respectively, a first contact lens primary functionality and a second contact lens primary functionality. “Primary functionality” is meant to be the primary or main feature of the lens. By way of example, such primary functionality may be vision correction, light management, cosmetic effect, or condition treatment including therapy based on drug delivery or therapy based on a system of lenses having different optics or absorption characteristics that may be worn in a prescribed sequence to address a vision need, such as myopia progression.

The vision correction functionality typically has the purpose of correcting refractive error and other conditions related to sight, for instance, correcting myopia or hyperopia, astigmatism, presbyopia, or combinations of such conditions.

A lens with light management functionality typically provides a benefit associated with the transmittance of light through the lens. Examples of such functionality include lenses that absorb light in specific ranges, such as UV or visible light, or specific regions within the visible light spectrum, such as HEV light. Preferably, the light management functionality comprises absorption in the visible light region of the spectrum (e.g., within the range of 380 to 760 nm), or in the HEV region (e.g., 380 to 450 nm). The light management functionality may be static (the light absorption of the lens doesn't change) or dynamic. An example of a dynamic light management functionality is photochromism. A photochromic lens changes its visible light transmittance based on the wavelength and intensity of light in the environment. For instance, a photochromic lens is activated to a darkened state when exposed to a specific wavelength of light, such as UV light, e.g., when a patient wears the lens outside. When the activating light is removed (e.g., the patient goes indoors), the lens returns to its deactivated (non-darkened) state.

The light management lens may contain the light managing material in any configuration, including an edge-to-edge lens design, a pupil-only lens design, or geometrically patterned lens design, which may provide cosmetic effect, protective effect or cooperate or augment the vision correction functionality of the lens.

Another exemplary primary functionality is cosmetic effect. Cosmetic lenses are typically used to change the appearance of the eye. For instance, enhancement tint contact lenses have a translucent tint that is meant to enhance the wearer's natural eye color. A color tint contact lens comprises a darker, opaque tint meant to change the wearer's eye color. A patterned lens can make the eye appear more complex, while a limbal ring in the contact lens can make the eye appear larger.

Lenses that have condition treatment as their primary functionality are directed at treating, reducing, or preventing eye conditions other than (or in addition to) vision correction. Examples of such lenses include, but are not limited to, those directed at allergies, dry eye or providing an antimicrobial effect. A lens combined with a therapeutic can directly address these conditions. Alternatively, conditions such as myopia progression may be treated with lenses having regions of peripheral blur, thus instead of the incorporation of a therapeutic, the subject is treated with a system of lenses having different power profiles to address and mitigate myopia progression.

As will be appreciated, a lens may possess more than one functionality. In particular, it is typical for lenses to provide vision correction, even if they have some other feature or function (e.g., light management). For purposes of the invention, in lenses that exhibit two functionalities, one of which is vision correction, the primary functionality is herein designated as the non-vision correction feature of the lens. Thus, in a lens that corrects vision and manages light, the primary functionality is light management. Similarly, in a lens that corrects vision and provides condition treatment, the primary functionality is condition treatment. By way of further example, in a lens that corrects vision and also provides cosmetic effect, the cosmetic effect is the primary functionality. The primary functionality of a plano lens (non-vision correcting lens) is the special feature or use of the lens such as cosmetic effect or ophthalmic bandage for wound healing.

The first and second contact lenses contained in the vision care kit of the invention have, respectively, a first contact lens modality and a second contact lens modality. The term “modality” refers to how long a lens is designed to be worn before replacement. For example, “daily wear disposable contacts lenses” are indicated for single use, typically one day, and are discarded after the single use. “Daily wear reusable contact lenses” are indicated for wear while a patient is awake and are removed before sleep. Daily wear reusable contact lenses are typically cleaned every night and discarded after one week, two weeks, or one month of total wear. “Extended wear contact lenses” are another type of modality and are typically worn continuously for up to 6, 14 or 30 consecutive days and nights.

The first and second contact lenses may independently be hard lenses, semi-rigid lenses, hybrid lenses, smart lenses, or soft lenses. Hybrid lenses usually have a rigid insert encapsulated in a hydrogel shell or surrounded by a hydrogel skirt. Smart lenses may respond to the ocular environment or contain encapsulated electronic components such as microprocessors, antennas, sensors, batteries, and circuits. Preferred are soft contact lenses, and particularly hydrogel lenses. Hydrogel lenses may be conventional hydrogels or silicone hydrogels.

“Conventional hydrogels” refer to polymeric networks made from components without any siloxy, siloxane or carbosiloxane groups. Conventional hydrogels are prepared from reactive mixtures comprising hydrophilic monomers that, when polymerized, form the base material of the lens. Examples of hydrophilic monomers include hydrophilic monomers, such as 2-hydroxyethyl methacrylate (“HEMA”), N,N-dimethylacrylamide (DMA), and N-vinyl pyrrolidone (“NVP”). U.S. Pat. Nos. 4,436,887, 4,495,313, 4,889,664, 5,006,622, 5,039459, 5,236,969, 5,270,418, 5,298,533, 5,824,719, 6,420,453, 6,423,761, 6,767,979, 7,934,830, 8,138,290, and 8,389,597, which are incorporated herein by reference, disclose the formation of conventional hydrogels. Conventional hydrogels may also be formed from polyvinyl alcohol. Commercially available conventional hydrogel base lens materials include, but are not limited to, etafilcon, genfilcon, hilafilcon, lenefilcon, nelfilcon, nesofilcon, ocufilcon, omafilcon, polymacon, and vifilcon, including all of their variants. Conventional hydrogel lenses may contain a coating, and the coating may be the same or different material from the substrate. Conventional lenses may include additives such as polyvinyl pyrrolidone, and comonomers including phosphoryl choline, methacrylic acid and the like.

“Silicone hydrogels” refer to polymeric networks made from at least one hydrophilic component and at least one silicone-containing component that, when polymerized, form the base material of the lens. Examples of suitable families of hydrophilic components that may be present in the reactive mixture include (meth)acrylates, styrenes, vinyl ethers, (meth)acrylamides, N-vinyl lactams, N-vinyl amides, N-vinyl imides, N-vinyl ureas, O-vinyl carbamates, O-vinyl carbonates, other hydrophilic vinyl compounds, and mixtures thereof. Silicone-containing components are well known and have been extensively described in the patent literature. For instance, the silicone-containing component may comprise at least one polymerizable group (e.g., a (meth)acrylate, a styryl, a vinyl ether, a (meth)acrylamide, an N-vinyl lactam, an N-vinylamide, an O-vinylcarbamate, an O-vinylcarbonate, a vinyl group, or mixtures of the foregoing), at least one siloxane group, and one or more linking groups connecting the polymerizable group(s) to the siloxane group(s). The silicone-containing components may, for instance, contain from 1 to 220 siloxane repeat units. The silicone-containing component may also contain at least one fluorine atom.

Examples of silicone hydrogel base lens materials include acquafilcon, asmofilcon, balafilcon, comfilcon, delefilcon, enfilcon, fanfilcon, formofilcon, galyfilcon, lotrafilcon, narafilcon, riofilcon, samfilcon, senofilcon (including senofilcon A or senofilcon C), somofilcon, and stenfilcon, including all of their variants, as well as silicone hydrogels as prepared in U.S. Pat. Nos. 4,659,782, 4,659,783, 5,244,981, 5,314,960, 5,331,067, 5,371,147, 5,998,498, 6,087,415, 5,760,100, 5,776,999, 5,789,461, 5,849,811, 5,965,631, 6,367,929, 6,822,016, 6,867,245, 6,943,203, 7,247,692, 7,249,848, 7,553,880, 7,666,921, 7,786,185, 7,956,131, 8,022,158, 8,273,802, 8,399,538, 8,470,906, 8,450,387, 8,487,058, 8,507,577, 8,637,621, 8,703,891, 8,937,110, 8,937,111, 8,940,812, 9,056,878, 9,057,821, 9,125,808, 9,140,825, 9156,934, 9,170,349, 9,244,196, 9,244,197, 9,260,544, 9,297,928, 9,297,929 as well as WO 03/22321, WO 2008/061992, and US 2010/0048847. These patents are hereby incorporated by reference in their entireties. Silicone hydrogel lenses may contain a coating, and the coating may be the same or different material from the substrate.

The first contact lens base material and the second contact lens base material may be substantially the same. By “substantially the same” in this context is meant that the lenses are made from the same hydrophilic monomer(s) and, if present, the same silicone-containing component(s). The amounts of the hydrophilic monomers and silicone-containing components may differ between the first and second lenses, but the lenses' base materials are still considered to be substantially the same for purposes of the invention. In addition, other monomers and additives (e.g., crosslinkers, polymerization initiators, functional monomers, such as UV/HEV absorbing or photochromic monomers, wetting agents, therapeutic agents and nutraceuticals) may, for example, be included in one lens and not the other, but the base material of the lenses is still considered to be substantially the same if the lenses are made from the same hydrophilic monomer(s) and, if present, the same silicone-containing component(s). The first contact lens and the second contact lens are considered to be of substantially the same base material if they have the same United States Adopted Name (USAN), regardless of the letter that may follow the name (e.g., senofilcon A and senofilcon C are substantially the same base material).

An advantage is provided to the wearer by having first contact lenses and second contact lenses that are made of substantially the same base material. In particular, the patient is able to use a material that they are comfortable with and can therefore easily switch between lens types, thus allowing them to receive the benefit of different primary functionalities and/or modalities in their lenses without having to adjust to a new material.

Preferably, the first contact lens base material may be etafilcon and the second contact lens base material may be etafilcon.

Preferably, the first contact lens base material may be senofilcon and the second contact lens base material may be senofilcon.

Alternatively, the first and second contact lenses may be made from different materials. For example, the wearer may choose etafilcon for their daily wear disposable contact lenses and senofilcon for the daily wear reusable contact lenses. This situation may occur, for example when some modalities and/or functionalities are only offered in one material. Furthermore, there may be contact lens wearers who would choose the first and second contact lens that are manufactured by different companies using the same or different materials. Again, this situation may arise when, for instance, some modalities and/or functionalities are only offered by one company but are required infrequently because of use or lifestyle. The vision care kits of the invention may include such combinations of lenses made of different materials or from different companies.

In the vision care kit of the invention, the first and second contact lenses differ from each based on their modalities, their primary functionalities, or both. Thus, the vision care kits of the invention allow for greater flexibility and customization to meet contact lens wearers' particular needs. The vision care kits of the invention are not limited to containing only two types of lenses. They may contain third, fourth, etc., lenses. Such third (or fourth, etc.) lenses may have primary functionalities or modalities that differ from the other contact lens types present in the vision care kit.

Preferred vision care kits according to the invention include, but are not limited to, the following.

The vision care kit may comprise a first contact lens and a second contact lens, wherein the first contact lens modality and the second contact lens modality are independently selected from a daily wear disposable modality, daily wear reusable modality, and an extended wear modality. Preferably, the first contact lens is a daily wear disposable modality and the second contact lens is a daily wear reusable modality lasting for two weeks (biweekly). Such kits are well suited for a variety of patients, including those that desire the convenience of daily disposables but wish to minimize the added cost of adopting these lenses for everyday use. Instead, the patient may wear the 2-week reusable lenses for some of the time, and save the daily disposables for, for instance, travel. Exemplary lenses for this kit include a first contact lens that is ACUVUE OASYS® 1-Day (senofilcon A) and a second contact lens that is ACUVUE OASYS® 2-Week (senofilcon A) or a first contact lens that is 1-Day ACUVUE MOIST (etafilcon A) and a second contact lens that is ACUVUE OASYS® 2-Week (senofilcon A).

In addition to cost savings, a particular benefit of a vision care kit that contains ACUVUE OASYS® brand lenses for both modalities is that the patient experiences the advantages described above from using lenses made of the same or similar base material. Moreover, the patient benefits from the sharper vision that is known to be provided by ACUVUE OASYS® 1-Day lenses and can therefore use the 1-Day lenses for those activities where sharper vision is particularly desirable, such as playing sports or hunting.

The vision care kit may comprise a first contact lens that provides condition treatment as its primary functionality and a second contact lens that provides vision correction as its primary functionality. Preferably, the primary functionality of the first contact lens is treatment of allergies. Such kits are well suited for a variety of patients, including those that desire the benefit of lenses that assist with allergies when they need them, and lenses which do not treat allergies when they don't. Instead, the patient may wear the vision correcting lenses for some of the time, and save the allergy lenses for, for instance, those periods when allergy triggers are particularly prevalent. Exemplary lenses for this kit include a first contact lens that is an etafilcon allergy lens and a second contact lens that is an ACUVUE® MOIST (etafilcon) contact lens. Both the first and second contact lens may have the same or different modalities. For instance, the first lens may be a 1-day disposable while the second may be a 2-week reusable, or both lenses may be 1-day disposables or both may be 2-week reusables. In mitigating myopia progression, the first lens may be a lens having the required vision correction, while the second contact lens can be a myopia progression treating lens, such as a having altered power profiles to treat myopia progression. Alternatively, a corneal reshaping lens can be the second lens which may be worn overnight.

The vision care kit may comprise a first contact lens that provides light management benefits as its primary functionality and a second contact lens that provides vision correction as its primary functionality. Preferably, the primary functionality of the first contact lens is photochromism. Such kits are well suited for a variety of patients, including those that desire the benefit of photochromic lenses but not necessarily for everyday use. Thus, the patient may wear the vision correcting lenses for some of the time and save the photochromic lenses for outside activities. Exemplary lenses for this kit include a first contact lens that is a senofilcon photochromic contact lens and a second contact lens that is a senofilcon vision correcting lens (e.g., ACUVUE OASYS® brand lenses). Both the first and second contact lens may have the same or different modalities. For instance, the first lens may be a 2-week or 4 week daily wear reusable contact lens, while the second may be a daily wear disposable contact lens, or both may be 2-week or 4-week reusables, or both may be 1-day disposables. By way of more specific example, the first contact may be a daily wear disposable photochromic contact lens and the second contact lens may be a daily wear disposable vision correcting lens.

The vision care kit may comprise contact lenses with different prescriptions for the same eye. For example, the kit may include daily wear disposable multifocal lenses for office work, daily wear reusable distance-only light management contact lenses for outside activities like sports, hunting, driving, flying, and the like, or lenses optimized for computer work, and so on for each eye independently. The vision care kit may comprise different sets of contact lenses that vary in prescription, primarily functionality, and modality for each eye. In many cases, a wearer's prescription in each eye is different from each other.

Exemplary vision care kits are shown in Table 1.

TABLE 1

| First contact lens | Second contact lens |
|---|---|
| Daily Wear Disposable | Daily Wear Biweekly Reusable |
| Daily Wear Disposable | Daily Wear Monthly Reusable |
| Daily Wear Disposable - Cosmetic | Daily Wear Disposable - Vision |
| | Correction |
| Daily Wear Disposable - Vision | Daily Wear Disposable - Allergy |
| Correction | |
| Daily Wear Disposable - Vision | Daily Wear Disposable - |
| Correction | Photochromic |
| Daily Wear Biweekly Reusable - | Daily Wear Biweekly Reusable - |
| Photochromic | Vision Correction |
| Daily Wear Disposable - Multifocal | Daily Wear Biweekly Reusable |
| Daily Wear Disposable - Vision | Daily Wear Disposable - Myopia |
| Correction | Control |

Further exemplary vision care kits are demonstrated in the Examples below.

Various amounts of each contact lens type may be included in a vision care kit of the invention. By way of example, the kit may contain a supply of lenses for a particular period of time (such as yearly, quarterly, monthly, or weekly), at any number ratio of first contact lens to second lens or at any relative percentage of first contact lens to second contact lens, depending on the modalities of the lenses and intended wear cycle of the wearer. The lenses may be organized in groups within the vision care kit, for instance selected from weekly, monthly, or quarterly time intervals. By way of example, a kit of the invention may contain sufficient lenses to permit a first contact lens to be worn on each eye from 2 percent to 98 percent of the time (total wear time), alternatively from10 percent to 90 percent of the time, alternatively from 23 percent to 77 percent, alternatively from 33.3 percent to 66.6 percent, or alternatively for 50 percent of the total wear time. For instance, a kit containing a 30 day supply of lenses for each eye of a wearer such that 33.3% of the lenses are of the first contact lens type and 66.6% are of the second contact lens type would allow the individual to wear the first contact lens type for 10 of the 30 days, and the second contact lens type for 20 of the 30 days. Similarly, a kit containing a 365 day supply of lenses such that 33.3% of the lenses are of the first contact lens type and 66.6% are of the second contact lens type would allow the individual to wear the first contact lens type for 122 of the 365 days, and the second contact lens type for 243 of the 365 days.

Example lens quantities are shown in Table 2.

TABLE 2

| | | Wear Scenario |
|---|---|---|
| CL 1 | CL 2 | % CL1 to % CL2 |
| Daily Wear Disposable | Daily Wear Biweekly Reusable | 40-60% CL1 |
| | | remainder CL 2 |
| Daily Wear Disposable | Daily Wear Biweekly Reusable | 70-90% CL 1 |
| | | remainder CL 2 |
| Daily Wear Disposable | Daily Wear Monthly Reusable | 40-60% CL 1 |
| | | remainder CL2 |
| Daily Wear Disposable - Cosmetic | Daily Wear Disposable - Vision | 25-35% CL 1 |
| | Correction | remainder CL2 |
| Daily Wear Disposable - Vision | Daily Wear Disposable - Allergy | 70-90% CL 1 |
| Correction | | remainder CL 2 |
| Daily Wear Disposable - Vision | Daily Wear Disposable - Photochromic | 70-90% CL 1 |
| Correction | | remainder CL 2 |
| Daily Wear Biweekly Reusable - | Daily Wear Biweekly Reusable - Vision | 15-25% CL 1 |
| Photochromic | Correction | remainder CL 2 |
| Daily Wear Disposable - Multifocal | Daily Wear Biweekly Reusable | 60-80% CL1 |
| | | remainder CL 2 |
| Daily Wear Disposable - Vision | Daily Wear Disposable - Photochromic | 70-90% CL 1 |
| Correction | | remainder CL 2 |
| Daily Wear Disposable - Vision | Daily Wear Disposable - Myopia | 40-60% CL 1 |
| Correction | Control | remainder CL 2 |
| Daily Wear Disposable | Daily Wear Monthly Reusable | 10-30% CL 1 |
| | | remainder CL 2 |
| Daily Wear Disposable - Vision | Daily Wear Disposable - Myopia | 40-60% CL 1 |
| Correction | Control | remainder CL 2 |
| Daily Wear Disposable - Vision | Daily Wear Disposable - Myopia | 10-30% CL 1 |
| Correction | Control | remainder CL 2 |
| Daily Wear Disposable | Daily Wear Biweekly Reusable | 10-30% CL 1 |
| | | remainder CL 2 |

Further illustrations of lens quantities are provided in the Examples below.

### EXAMPLES

Examples 1-28 in Table 1 illustrate vision care kits according to the invention (CL=contact lens). The contents of Table 3 assume that the vision care kit includes contact lenses for both eyes although their prescriptions may be different.

TABLE 3

| | | | | Approximate | | |
|---|---|---|---|---|---|---|
| | | | | Annual | | |
| | | | Wear | Supply | | |
| | | | Scenario | Number of | CL 1 | CL 2 |
| | | | % CL1 to % | Lenses | Exemplary | Exemplary |
| Ex. | CL 1 | CL 2 | CL2 | CL 1:CL 2 | Brands | Brands |
| 1 | Daily Wear | Daily Wear | 50% CL1 | 366:26 | ACUVUE | ACUVUE |
| | Disposable | Biweekly | 50% CL 2 | | OASYS ® 1- | OASYS ® 2- |
| | | Reusable | | | Day | Week |
| 2 | Daily Wear | Daily Wear | 77% CL 1 | 562:12 | 1-Day | ACUVUE |
| | Disposable | Biweekly | 23% CL 2 | | ACUVUE ® | OASYS ® 2- |
| | | Reusable | | | MOIST | Week |
| 3 | Daily Wear | Daily Wear | 50% CL 1 | 366:12 | ACUVUE | ACUVUE |
| | Disposable | Monthly | 50% CL2 | | OASYS ® 1- | VITA ® |
| | | Reusable | | | Day | |
| 4 | Daily Wear | Daily Wear | 28% CL 1 | 208:522 | ACUVUE ® | ACUVUE ® |
| | Disposable - | Disposable - | 72% CL2 | | DEFINE ® | MOIST |
| | Cosmetic | Vision Correction | | | | |
| 5 | Daily Wear | Daily Wear | 80% CL 1 | 584:146 | 1-Day | Etafilcon |
| | Disposable - | Disposable - | 20% CL 2 | | ACUVUE ® | comprising an |
| | Vision | Allergy | | | MOIST | allergy drug |
| | Correction | | | | | |
| 6 | Daily Wear | Daily Wear | 80% CL 1 | 584:146 | ACUVUE | ACUVUE |
| | Disposable - | Disposable - | 20% CL 2 | | OASYS ® 1- | OASYS 1-Day |
| | Vision | Photochromic | | | Day | with |
| | Correction | | | | | Photochromics |
| 7 | Daily Wear | Daily Wear | 20% CL 1 | 10:42 | ACUVUE | ACUVUE |
| | Biweekly | Biweekly | 80% CL 2 | | OASYS ® with | OASYS ® 2- |
| | Reusable - | Reusable - Vision | | | Transitions ® | Week |
| | Photochromic | Correction | | | Light Intelligent | |
| | | | | | Technology ™ | |
| 8 | Daily Wear | Daily Wear | 70% CL1 | 512:16 | 1-Day | ACUVUE |
| | Disposable - | Biweekly | 30% CL 2 | | ACUVUE | OASYS ® 2- |
| | Multifocal | Reusable | | | MOIST ® | Week |
| | | | | | Multifocal | |
| 9 | Daily Wear | Daily Wear | 50% CL1 | 366:26 | Dailies Total | ACUVUE |
| | Disposable | Biweekly | 50% CL 2 | | 1 ® | OASYS ® 2- |
| | | Reusable | | | | Week |
| 10 | Daily Wear | Daily Wear | 50% CL1 | 366:26 | Dailies ® | ACUVUE |
| | Disposable | Biweekly | 50% CL 2 | | AquaComfort | OASYS ® 2- |
| | | Reusable | | | Plus ® | Week |
| 11 | Daily Wear | Daily Wear | 50% CL1 | 366:26 | Biotrue ® | Avaira Vitality ® |
| | Disposable | Biweekly | 50% CL 2 | | ONEday Lenses | |
| | | Reusable | | | | |
| 12 | Daily Wear | Daily Wear | 50% CL1 | 366:26 | MyDay ® daily | ACUVUE |
| | Disposable | Biweekly | 50% CL 2 | | disposable | OASYS ® 2- |
| | | Reusable | | | | Week |
| 13 | Daily Wear | Daily Wear | 50% CL1 | 366:26 | Clariti ® one | ACUVUE |
| | Disposable | Biweekly | 50% CL 2 | | day | OASYS ® 2- |
| | | Reusable | | | | Week |
| 14 | Daily Wear | Daily Wear | 50% CL1 | 366:26 | ACUVUE | Avaira Vitality ® |
| | Disposable | Biweekly | 50% CL 2 | | OASYS ® 1- | |
| | | Reusable | | | Day | |
| 15 | Daily Wear | Daily Wear | 50% CL 1 | 366:12 | ACUVUE | Air Optix ® |
| | Disposable | Monthly | 50% CL 2 | | OASYS ® 1- | Aqua |
| | | Reusable | | | Day | |
| 16 | Daily Wear | Daily Wear | 50% CL 1 | 366:12 | ACUVUE | Biofinity ® |
| | Disposable | Monthly | 50% CL 2 | | OASYS ® 1- | |
| | | Reusable | | | Day | |
| 17 | Daily Wear | Daily Wear | 50% CL 1 | 366:12 | ACUVUE | Ultra ® |
| | Disposable | Monthly | 50% CL 2 | | OASYS ® 1- | |
| | | Reusable | | | Day | |
| | Daily Wear | Daily Wear | 50% CL 1 | 366:12 | ACUVUE | ACUVUE Vita ® |
| | Disposable | Monthly | 50% CL 2 | | OASYS ® 1- | |
| | | Reusable | | | Day | |
| 18 | Daily Wear | Daily Wear | 80% CL 1 | 584:146 | Dailies Total | ACUVUE |
| | Disposable - | Disposable - | 20% CL 2 | | 1 ® | OASYS 1-Day |
| | Vision | Photochromic | | | | with |
| | Correction | | | | | Photochromics |
| 19 | Daily Wear | Daily Wear | 50% CL 1 | 365:365 | ACUVUE | MiSight ® 1 day |
| | Disposable - | Disposable - | 50% CL 2 | | OASYS ® 1- | |
| | Vision | Myopia Control | | | Day | |
| | Correction | | | | | |
| 20 | Daily Wear | Daily Wear | 50% CL 1 | 365:365 | 1-Day | MiSight ® 1 day |
| | Disposable - | Disposable - | 50% CL 2 | | ACUVUE ® | |
| | Vision | Myopia Control | | | MOIST | |
| | Correction | | | | | |
| 21 | Daily Wear | Daily Wear | 50% CL 1 | 366:12 | Biotrue ® | Ultra |
| | Disposable | Monthly | 50% CL 2 | | ONEday Lenses | |
| | | Reusable | | | | |
| 22 | Daily Wear | Daily Wear | 20% CL 1 | 146:20 | Biotrue ® | Ultra |
| | Disposable | Monthly | 80% CL 2 | | ONEday Lenses | |
| | | Reusable | | | | |
| 23 | Daily Wear | Daily Wear | 50% CL 1 | 365:365 | My Day or | MiSight ® 1 day |
| | Disposable - | Disposable - | 50% CL 2 | | Clariti | |
| | Vision | Myopia Control | | | | |
| | Correction | | | | | |
| 24 | Daily Wear | Daily Wear | 20% CL 1 | 146:584 | Proclear | MiSight ® 1 day |
| | Disposable - | Disposable - | 80% CL 2 | | (omafilcon) | |
| | Vision | Myopia Control | | | | |
| | Correction | | | | | |
| 25 | Daily Wear | Daily Wear | 20% CL 1 | 146:20 | My Day or | Biofinity |
| | Disposable | Monthly | 80% CL 2 | | Clariti | |
| | | Reusable | | | | |
| 26 | Daily Wear | Daily Wear | 20% CL 1 | 146:42 | MyDay or | Avaira |
| | Disposable | Biweekly | 80% CL 2 | | Clariti | |
| | | Reusable | | | | |
| 27 | Daily Wear | Daily Wear | 20% CL 1 | 146:20 | Dailies Total 1 | Air Optix ® |
| | Disposable | Monthly | 80% CL 2 | | or Precision 1 | Aqua |
| | | Reusable | | | | |
| 28 | Daily Wear | Daily Wear | 20% CL 1 | 146:20 | Dailies Total 1 | Air Optix ® |
| | Disposable | Monthly | 80% CL 2 | or Precision 1 | Aqua | |
| | | Reusable | | | | |

Notes:
ACUVUE ® brands currently sold by Johnson & Johnson Vision Care; DAILIES TOTAL 1 ® (delefilcon), AIR OPTIX AQUA ® (lotrafilcon), and DAILIES ® AQUACOMFORT PLUS ® (nelfilcon) brands currently sold by Alcon; MYDAY ® (stenfilcon) daily disposable, CLARITI ® (somofilcon) one day, AVAIRA VITALITY ® (fanfilcon), BIOFINITY ® (comfilcon), PROCLEAR (omafilcon) and MISIGHT ® 1 DAY (omafilcon) currently sold by CooperVision; and BIOTRUE ® ONEDAY (nesofilcon) Lenses and ULTRA ® (samfilcon) currently sold by Bausch and Lomb.

1. A vision care kit comprising:
(a) a first contact lens having a first contact lens primary functionality and a first contact lens modality; and
(b) a second contact lens having a second contact lens primary functionality and a second contact lens modality,
wherein (1) the first contact lens primary functionality is different from the second contact lens primary functionality; or (2) the first contact lens modality is different from the second contact lens modality; or (3) the first contact lens primary functionality is different from the second contact lens primary functionality and the first contact lens modality is different from the second contact lens modality.

2. The vision care kit of claim 1 wherein the first contact lens modality and the second contact lens modality are independently selected from a daily disposable wear modality and a daily wear reusable modality.

3. The vision care kit of claim 2 wherein the daily wear reusable modality is a biweekly modality or a monthly modality.

4. The vision care kit of claim 1 wherein the first contact lens primary functionality and the second contact lens primary functionality are independently selected from: vision correction, light management, cosmetic effect, and condition treatment.

5. The vision care kit of claim 4 wherein vision correction is for myopia or hyperopia, astigmatism, presbyopia, or combinations thereof.

6. The vision care kit of claim 4 wherein the light management functionality is visible light absorption, photochromism, or combinations thereof.

7. The vision care kit of claim 6 wherein visible light absorption is high energy visible light absorption.

8. The vision care kit of claim 6 wherein the light management is selected from edge-to-edge lens design, pupil-only lens design, and geometrically patterned lens designs.

9. The vision care kit of claim 4 wherein the condition treatment is treatment of ocular allergies, dry eye, myopia progression, or combinations thereof.

10. The vision care kit of claim 1 wherein the first contact lens and the second contact lens are independently a silicone hydrogel, a conventional hydrogel, a coated silicone hydrogel, or a coated conventional hydrogel.

11. The vision care kit of claim 1 wherein the first contact lens is made of a first base lens material and the second contact lens is made of a second base lens material, wherein the first base material and the second base material are independently etafilcon, genfilcon, hilafilcon, lenefilcon, nelfilcon, nesofilcon, ocufilcon, omafilcon, polymacon, vifilcon, acquafilcon, asmofilcon, balafilcon, comfilcon, delefilcon, enfilcon, fanfilcon, formofilcon, galyfilcon, lotrafilcon, narafilcon, riofilcon, samfilcon, senofilcon, somofilcon, or stenfilcon.

12. The vision care kit of claim 11 wherein the first base lens material is substantially the same as the second base lens material.

13. The vision care kit of claim 12 wherein the first base lens material and the second base lens material are each senofilcon or the first base material and the second base material are each etafilcon.

14. The vision care kit of claim 1 comprising sufficient quantities of the first contact lens and the second contact lens to provide a one year supply, a one quarter supply, a one month supply, or a one week supply of contact lenses for a single patient.

15. The vision care kit of claim 1 further comprising a third contact lens having a third contact lens primary functionality and a third contact lens modality, wherein (1) the third contact lens primary functional is different from the first contact lens primary functionality, the second contact lens primary functionality, or both the first contact lens primary functionality and the second contact lens primary functionality; or (2) the third contact lens modality is different from the first contact lens modality, the second contact lens modality, or both the first contact lens primary modality and the second contact lens primary modality.

16. The vision care kit of claim 1 wherein the first contact lens and second contact lens are organized in groups selected from weekly, monthly, or quarterly time intervals.

17. A vision care method comprising the steps of:
identifying a patient with two or more vision care needs;
dispensing to the patient a vision care kit according to claim.

18. The vision care kit of claim 1 wherein the first contact lens primary functionality or the second contact lens primary functionality is light management.

19. The vision care kit of claim 18 wherein the light management comprises static or dynamic absorption of visible light.

20. The vision care kit of claim 11 wherein the first base lens material is different from the second base lens material.
